(19) United States
(12) Patent Application Publication
(10) Pub. No.: US 2009/0036572 A1
(43) Pub. Date: Feb. 5, 2009

(54) Method For Waterproofing A Gypsum-Based Product Formed From A Plaster-Based Composition

(75) Inventor: Emmanuel Geeraert, Kapellen (BE)

Correspondence Address: YOUNG & THOMPSON, 209 Madison Street, Suite 500, ALEXANDRIA, VA, 22314, US

(73) Assignee: BPB LTD., London (GB)

(21) Appl. No.: 12/280,685

(22) PCT Filed: Feb. 27, 2007
(86) PCT No.: PCT/IB2007/001417

§ 371 Date: Aug. 26, 2008

(30) Foreign Application Priority Data
Feb. 28, 2006 (FR) 0601761

(51) Int. Cl. C04B 24/28

(52) U.S. Cl. 524/3

(57) ABSTRACT

A method of imparting water repellency to a gypsum-based product formed from a plaster-based composition, includes adding to the composition at least one compound including a polysiloxane and at least one compound comprising a pregelled starch. A hydrophobicized, plaster-based composition including a polysiloxane and at least one compound comprising a pregelled starch, and its uses are also disclosed.

The invention relates to a method for waterproofing a gypsum-based product formed from a plaster-based composition, a waterproofed plaster-based composition, and the use of such a composition for the manufacture of moulded or extruded items, such as plaster blocks or boards.

The raw material gypsum, whether of natural or synthetic origin, is a calcium sulphate dihydrate. This gypsum, in powder form, is firstly subjected to heating, which dehydrates it to produce calcium sulphate hemi-hydrate or anhydrous calcium sulphate or a mixture of these two forms. This dehydrated product is called plaster. On mixing this plaster with water, a blend is obtained which solidifies, re-forming gypsum (calcium sulphate dihydrate). In order to obtain a blend which can be poured, in order to allow the desired product to be shaped, excess water is used in the blend. During drying of the product, this excess water is evaporated, leaving micropores in the product. This porosity is responsible for uptake of water by the product, for example, on immersion. The subject of the present invention is the reduction of this uptake of water by the product.

If necessary, suitable additives can be added to the blend, such as setting accelerators, setting retarders, lightening products, rheology modifiers, fillers, fibres, other functional additives such as starch, silicone oil, wax or any other additive usual in the field.

As gypsum is a porous and hydrophilic product, it is liable to water uptake when in the presence of water.

Water absorption in gypsum-based products formed from a plaster-based composition results in particular in a reduction in mechanical strength and the possibility of deformation of these items under stress.

Therefore, it is sought to reduce the water uptake of gypsum in order to give the gypsum-based products properties of mechanical stability compatible with their use.

The use of organosilicones to confer mass waterproofing properties on gypsum-based compositions is described, for example, in patents EP 0 171 018 and U.S. Pat. No. 5,814,411 where the waterproofing agent is inserted with foam.

A method of waterproofing plaster by adding an alkylhydrogenopolysiloxane and guar gum is described in Application WO99/50200.

Application DE 102 20659 describes gypsum-based compositions comprising siloxanes and etherified derivatives of starch.

It has now been found that adding a compound comprising a polysiloxane and at least one compound comprising a pregelified starch to a plaster-based composition makes it possible to give highly waterproof properties to a gypsum-based product prepared from this composition, i.e. reducing its water absorption significantly in comparison with a formulation not containing pregelified starch.

Surprisingly, it has in fact been found that adding pregelified starch makes it possible to reduce significantly the quantity of silicone necessary to obtain this reduction in water absorption, while this is not the case if native starch is used. It has been noted that during the manufacture of a plaster board, the native starch conventionally added to the blend, which is a partially hydrolysed native starch, has no major influence on the reduction in water absorption of the board.

Advantageously, it has also been found that adding pregelified starch makes it possible to obtain results in terms of waterproofing equivalent, or even superior to, those obtained by the addition of guar, whilst allowing production costs to be optimized.

Thus according to a first aspect, the subject of the invention is a method for waterproofing a gypsum-based product formed from a plaster-based composition, characterized in that at least one compound comprising a polysiloxane and at least one compound comprising a pregelified starch is added to said composition.

According to a preferred aspect, said polysiloxane can be chosen, for example, from the linear or cyclic hydrogenopolysiloxanes of Formula (I) or (II) below,

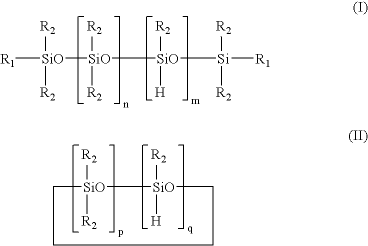

or mixtures of these, in which:

R₁ and R₂, identical or different, represent independently

a C₁-C₈ linear or branched alkyl radical;

a C₁-C₄ alkoxy radical; a C₃-C₁₀ cycloalkyl radical;

a C₆-C₁₄ monocyclic, bicyclic or tricyclic aryl radical, non-substituted or substituted by at least one C₁-C₄ alkyl radical or a C₂-C₁₂ alkenyl radical;

a monocyclic or bicyclic aralkyl radical in which the aryl group(s) is(are) C₆-C₁₀ and the alkyl group is C₁-C₄, non-substituted or substituted by at least one C₁-C₄ alkyl radical or a C₂-C₁₂ alkenyl radical;

a C₅-C₁₂ monocyclic or bicyclic heteroaryl radical comprising at least one heteroatom chosen from O, N and S, a C₂-C₁₂ alkenyl radical;

or a C₂-C₁₂ alkynyl radical;
n, m, p and q are integers comprised between 0 and 200, with I<n+m<200 and 3<p+q<10.

Preferably, said polysiloxane has at least one free hydrogen atom bound to one atom of silicon, per molecule,

Non-limitative examples of the radicals and groups mentioned above in the definition of R₁ and R₂ are given below.

By “C₁-C₈ linear or branched alkyl radical” is meant, for example, methyl, ethyl, propyl, isopropyl, n-butyl, sec-butyl, tert-butyl, isobutyl, pentyl, hexyl, octyl.

By “C₁-C₄ aloxy radical” is meant, for example, a linear or branched group such as methoxy, ethoxy, propoxy, isopropoxy, n-butoxy, sec-butoxy, tert-butoxy or isobutoxy.

By “C₃-C₁₀ cycloalkyl radical” is meant, for example, a cyclopropyl, cyclobutyl, cyclopentyl or cyclohexyl group,

By “C₆-C₁₄ monocyclic, bicyclic or tricyclic aryl radical” is meant, for example, a phenyl, biphenyl, naphthyl or anthracenyl group, said groups being substituted or non-substituted.

By “monocyclic or bicyclic aralkyl radical in which the aryl group(s) is (are) C₆-C₁₀ and the alkyl group is C₁-C₄” is meant, for example, a benzyl, phenylethyl, phenylpropyl, triphenylmethyl or naphthylmethyl group, said groups being substituted or non-substituted.

By “C₅-C₁₂ monocyclic or bicyclic heteroaryl radical comprising at least one heteroatom chosen from O, N and S” is meant, for example, a pyrrolyl, furanyl, thienyl, pyridyl, indolyl, benzopyrrolyl, benzofuranyl, benzothiophenyl, benzothienyl, benzimidazolyl, benzopurinyl, quinoleyl, isoquinoleyl, imidazolyl, thiazolyl, thiadiazolyl, oxazolyl, oxadiazolyl pyrazinyl, pyrimidyl, pyridazinyl or purinyl group.

By “C₂-C₁₂ alkenyl radical” is meant a hydrocarbon radical comprising one or more double bond(s), for example a vinyl, allyl or crotonyl group.

By “C₂-C₁₂ alkynyl radical” is meant a hydrocarbon radical comprising one or more triple bond(s), for example an ethynyl, propargyl, butynyl, pentynyl or hexynyl group.

Preferred polysiloxanes for the purposes of the invention are, for example, polymethylhydrogenosiloxane and polymethylvinylsiloxane.

Preferably, the compound comprising a polysiloxane in the form of an oil or an oil-in-water emulsion will be used.

Said compound comprising a polysiloxane is preferably present in the composition in a ratio of 0.01% to 1.5% by weight to the gypsum powder, in particular in a ratio of 0.05% to 0.25% by weight to the gypsum powder.

The compound comprising a pregelified starch can result, for example, from pregelification of corn starch, wheat starch, potato starch, sweet potato starch, tapioca starch, manioc starch, rice starch, waxy maize starch or mixtures of these, or flours containing them.

By “pregelified starch” is meant a starch having undergone a treatment intended to make it soluble or suitable for dispersal in a liquid without heating.

After such treatment, a starch known as “pregelified” or “pregelatinized” is obtained, the two terms being interchangeable in the sense of this description.

The pregelification treatment can be carried out by heating said compound to above the gelification temperature of the starch, according to known techniques.

The starch can also be reticulated using a reticulation agent or under the effect of an ionizing radiation, according to standard techniques.

The compound comprising a pregelified starch can be in powder form or in solution in the water.

Preferably, the compound comprising a pregelified starch is present in the composition in a ratio of 0.025% to 2% by weight to the gypsum powder, in particular in a ratio of 0.10% to 1% to the gypsum powder.

The plaster composition to which are added the compound comprising a polysiloxane and the compound comprising a derivative of pregelified starch can also contain at least one additive used as standard in the field, such as for example a fluidifying agent or dispersant, a foaming agent, a setting retarder, a setting accelerator, a high-temperature anti-shrinkage agent, a binder, a native starch, an adhesive agent, a recalcination inhibitor, wax, a thickening agent, an anti-subsidence agent, a self-leveller, a biocide, a pH adjuster, a colorant, a reinforcing material, a flame retarder or a filler.

According to a subsequent aspect, the invention also relates to a waterproofing method as defined above, comprising a step consisting of preparing a mixture based on plaster, water, at least one compound comprising a polysiloxane and at least one compound comprising a pregelified starch, said compounds being as defined above.

The invention also relates to a waterproofed plaster-based composition, comprising at least one compound including a polysiloxane and at least one compound including a pregelified starch as defined above.

The invention also relates to a method for preparing a waterproofed plaster-based composition, comprising a step consisting of preparing a mixture based on plaster, water, at least one compound comprising a polysiloxane and at least one compound comprising a pregelified starch, said compounds being as defined above.

According to a subsequent aspect, the invention also relates to the use of such a composition for the manufacture of a moulded or extruded item, for example, for the manufacture of a plaster block or plaster board, as well as the moulded or extruded items, for example, the blocks or the boards comprising such a composition.

In fact, the waterproofing method and the waterproofed composition according to the invention make it possible to obtain gypsum-based products, the waterproof properties of which comply with the standards in force.

In this respect, reference will be made to Standard NF EN 520 which defines respectively water absorption classes H1, H2 and H3 for a total water absorption equal to or less than 5% (class H1), equal to or less than 10% (class H2), and equal to or less than 25% (class H3), after 2 hours' immersion in water.

In particular, the waterproofing method and the waterproofed composition according to the invention can be used for the manufacture of boards known as “plasterboards with reduced water absorption rate” of classes H1, H2 or H3 according to Standard NF EN 520, or any other type of gypsum-based board in which a reduction in the total water or a reduction in the surface water is desired, such as for example, boards reinforced by fibres (for example, synthetic fibres, cellulosic fibres, glass fibres, mineral fibres) or by mats, or nets, or by a combination of these different reinforcement elements.

Such types of board are described, for example, in the draft standards Pr NF EN 15283-1 (gypsum boards with fibrous reinforcement) and Pr NF 15283-2 (gypsum fibre boards).

A further subject of the invention is a product comprising in association at least one compound comprising a polysiloxane and at least one compound comprising a pregelified starch as defined above, for joint use in a waterproofing method of a gypsum-based product formed from a plaster-based composition.

By “joint use” is meant the use of at least one compound comprising a polysiloxane and at least one compound comprising a pregelified starch in order to obtain the desired waterproofing properties, i.e. a reduction of the water uptake of the product, the compound comprising a polysiloxane and the compound comprising a pregelified starch being capable of being introduced simultaneously or separately into the plaster-based composition.

The example below illustrates the invention non-limitatively.

### EXAMPLE 1

### 1) Preparation of Blocks

A mixture of powders is prepared, made up of (quantities expressed for 1 kg of plaster):
1 kg plaster (natural gypsum-based)
4.25 g pregelified starch powder or guar
4.7 g of starch (Collofilm 121, Amylum, Tate & Lyle)
0.05 g setting retarder (PlastRetard, SICIT)

which are added to a liquid mixture composed of 740 g water, 2.9 g fluidifying agent (Proxmat M115-40, Synthron) and silicone oil (H68, Rhodia, France) (see quantities in table 1 below).

Mixing is carried out using an 8 cm diameter disperser disk at 1500-2500 rpm.

During the mixing, 52 g of a foam prepared from 2 g foaming agent (Millifoam, Huntsman) in 200 ml water is added, using an 8 cm diameter disperser disk at 1000 rpm for 1 to 1.5 min.

This mixture is then used to fill silicone moulds for 6 blocks of the desired dimensions. When setting begins, the surface of the moulds is scraped to remove the excess blend. Removal from the mould takes place after hardening is complete.

Thus gypsum blocks of dimensions 150×75×12 mm are obtained, which are dried in an accelerated fashion in a microwave oven for approximately 25 min until they reach a residual humidity of approximately 3%, then dried in a kiln at 40° C. until they reach a constant weight.

### 2) Measurement of the Water Uptake

Measurements of water uptake by immersion were carried out according to Standard NF EN 520.

In brief, the blocks are immersed in water (23+/−2° C.) for 2 h+/−2 min and the increase in their mass is determined as a percentage.

The results are given in the Table 1 below.

TABLE 1

| | | Pregelified | | Water |
|---|---|---|---|---|
| | Silicone | starch | Guar | uptake |
| | (g/kg of | (g/kg of | (g/kg of | (total |
| | gypsum) | gypsum) | gypsum) | water %) |
| Comparative | 4.4 | — | — | 4.9 |
| formulation 1 | | | | |
| silicone only | | | | |
| Formulation 2 with | 1.7 | 4.25 | — | 1.5 |
| pregelified starch | | | | |
| (Solvitose H8, | | | | |
| AVEBE) | | | | |
| Formulation 3 with | 1.7 | 4.25 | — | 1.5 |
| pregelified starch | | | | |
| (Paselli WA, | | | | |
| AVEBE) | | | | |
| Comparative | 1.7 | — | 4.25 | 1.6 |
| formulation 4 with | | | | |
| guar (Rhoximat | | | | |
| 3407, RHODIA) | | | | |

The results show that formulations 2 and 3 according to the invention, which contain silicone and pregelified starch, have a lower water uptake than that obtained with comparative formulation 1, containing silicone only, in a larger quantity.

Moreover, they have a water uptake lower than comparative formulation 4, which contains the same quantity of silicone, but contains guar instead of the pregelified starch.

1. Method for waterproofing a gypsum-based product formed from a plaster-based composition, characterized in that at least one compound comprising a polysiloxane and at least one compound comprising a pregelified starch is added to said composition.

2. Method according to claim 1, characterized in that said polysiloxane is chosen from linear or cyclic hydrogenopolysiloxanes of formulae (I) or (II) below, 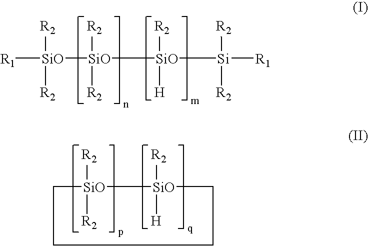
or mixtures of these, in which:
R₁ and R₂, identical or different, represent independently
a linear or branched C₁-C₈ alkyl radical;
a C₁-C₄ alkoxy radical; a C₃-C₁₀ cycloalkyl radical;
a C₆-C₁₄ monocyclic, bicyclic or tricyclic aryl radical, non-substituted or substituted by at least one C₁-C₄ alkyl radical or a C₂-C₁₂ alkenyl radical;
a monocyclic or bicyclic aralkyl radical in which the aryl group(s) is(are) C₆-C₁₀ and the alkyl group is C₁-C₄, non-substituted or substituted by at least one C₁-C₄ alkyl radical or a C₂-C₁₂ alkenyl radical;
a C₅-C₁₂ monocyclic or bicyclic heteroaryl radical comprising at least one heteroatom chosen from O, N and S,
a C₂-C₁₂ alkenyl radical;
or a C₂-C₁₂ alkynyl radical;
n, m, p and q are integers comprised between 0 and 200, with 1<n+m<200 and 3<p+q<10.

3. Method according to claim 1, characterized in that the compound comprising a polysiloxane is in the form of an oil or an oil-in-water emulsion.

4. Method according to claim 1, characterized in that said compound comprising a polysiloxane is present in the composition in a ratio of 0.01% to 1.5% by weight to the gypsum powder.

5. Method according to claim 4, characterized in that said compound comprising a polysiloxane is present in the composition in a ratio of 0.05% to 0.25% by weight to the gypsum powder.

6. Method according to claim 1, characterized in that the compound comprising a pregelified starch results from the pregelification of corn starch, wheat starch, potato starch, sweet potato starch, tapioca starch, manioc starch, rice starch, waxy maize starch or mixtures of these, or flours containing them.

7. Method according to claim 1, characterized in that the compound comprising a pregelified starch is present in the composition at a ratio of 0.025% to 2% by weight to the gypsum powder.

8. Method according to claim 7, characterized in that the compound comprising a pregelified starch is present in the composition at a ratio of 0.10% to 1% by weight to the gypsum powder.

9. Method according to claim 1, characterized in that the plaster-based composition comprises moreover at least one additive chosen from a fluidifying agent or dispersant, a foaming agent, a setting retarder, a setting accelerator, a high-temperature anti-shrinkage agent, a binder, a native starch, an adhesive agent, a recalcination inhibitor, wax, a thickening agent, an anti-subsidence agent, a self-leveller, a biocide, a pH adjuster, a colorant, a reinforcing material, a flame retarder or a filler.

10. Waterproofing method of a gypsum-based product formed from a plaster-based composition, characterized in that it comprises a step consisting of preparing a mixture based on plaster, water, at least one compound comprising a polysiloxane, and at least one compound comprising a pregelified starch, said compounds being as defined in claim 1.

11. Method according to claim 10, characterized in that at least one additive is added, chosen from a fluidifying agent or dispersant, a foaming agent, a setting retarder, a setting accelerator, a high-temperature anti-shrinkage agent, a birder, a native starch, an adhesive agent, a recalcination inhibitor, wax, a thickening agent, an anti-subsidence agent, a self-leveller, a biocide, a pH adjuster, a colorant, a reinforcing material, a flame retarder or a filler.

12. Waterproofed plaster-based composition, characterized in that it comprises at least one compound comprising a polysiloxane as defined in claim 1, and at least one compound comprising a pregelified starch.

13. Composition according to claim 12, characterized in that it contains a compound comprising a polysiloxane chosen from linear or cyclic hydrogenopolysiloxanes of formulae (I) or (IT) below, 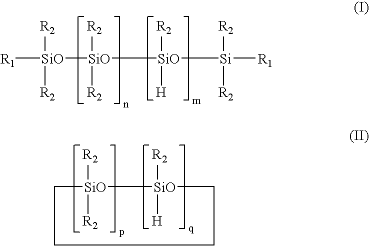
or mixtures of these, in which:
R₁ and R₂, identical or different, independently represent
a C₁-C₈ linear or branched alkyl radical;
a C₁-C₄ alkoxy radical; a C₃-C₁₀ cycloalkyl radical;
a C₆-C₁₄ monocyclic, bicyclic or tricyclic aryl radical, non-substituted or substituted by at least one C₁-C₄ alkyl radical or a C₂-C₁₂ alkenyl radical;
a monocyclic or bicyclic aralkyl radical in which the aryl group(s) is (are) C₆-C₁₀ and the alkyl group is C₁-C₄, non-substituted or substituted by at least one C™-C₄ alkyl radical or a C₂-C₁₂ alkenyl radical;
a C₅-C₁₂ monocyclic or bicyclic heteroaryl radical comprising at least one heteroatom chosen from O, N and S,
a C₂-C₁₂ alkenyl radical;
or a C₂-C₁₂ alkynyl radical;
n, m, p and q are integers comprised between 0 and 200, with 1<n+m<200 and 3<p+q<10.
and at least one compound comprising a pregelified starch.

14. Composition according to claim 12, characterized in that said compound comprising a polysiloxane is present in the composition in a ratio of 0.01% to 1.5% by weight to the gypsum powder, and in that the compound comprising a pregelified starch is present in the composition in a ratio of 0.25% to 2% by weight to the gypsum powder.

15. Method for the preparation of a waterproofed plaster-based composition, characterized in that it comprises a step consisting of preparing a mixture based on plaster, water, at least one compound comprising a polysiloxane, and at least one compound comprising a pregelified starch, said compounds being as defined in claim 1.

16-17. (canceled)

18. Moulded item, block or board comprising a waterproofed plaster-based composition, in which said composition comprises at least one compound comprising a polysiloxane and at least one compound comprising a pregelified starch as defined in claim 1.

19. Product comprising in association at least one compound comprising a polysiloxane and at least one compound comprising a pregelified starch as defined in claim 1, for joint use in a waterproofing method of a gypsum-based product formed from a plaster-based composition.
